(19) United States
(12) Patent Application Publication
(10) Pub. No.: US 2007/0182859 A1
(43) Pub. Date: Aug. 9, 2007

(54) Signal-processing system

(75) Inventors: Gerben Johan Hekstra, Eindhoven (NL); Ihor Kirenko, Eindhoven (NL); Marco Klaas Bosma, Eindhoven (NL); Frederik Jan De Bruijn, Eindhoven (NL); Gerard De Haan, Eindhoven (NL); Rogier Lodder, Bad Ragaz (CH); Abraham Karel Riemens, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/598,230

(22) PCT Filed: Feb. 24, 2005
(86) PCT No.: PCT/IB05/00497

§ 371 Date: Aug. 22, 2006

(30) Foreign Application Priority Data
Mar. 2, 2004 (EP) 04300108.0

(51) Int. Cl. H04N 5/21; H04N 9/64; H04N 5/14; H04N 5/91

(52) U.S. Cl. 348/625; 386/83

(57) ABSTRACT

The invention relates to a signal processing system comprising first electronic means for storing an input signal, second means for a real-time processing of the input signal thus stored, and third electronic means for storing the signal thus processed. This system is according to the invention, characterized in that said second processing means themselves comprise off-line signal enhancement means applied to said input signal and using available processing resources, not still used for real-time or on-line processing, for delivering an enhanced signal and storing it in said third means for storing the signal processed by the second processing means. The signal enhancement means may also comprise means for modifying said enhanced signal, said third electronic means for storing the processed signal being also able to store the enhanced signal thus modified, and the third electronic means for storing the signal processed may be provided for outputting the enhanced signal and/or the modified enhanced signal in real time.

### FIELD OF THE INVENTION

The present invention relates to a signal processing system comprising means for a real-time processing of the input signal received.

### BACKGROUND OF THE INVENTION

A processing arrangement enhancing at least one feature of a signal is described for instance in the U.S. Pat. No. 4,839,836 (PHF86519). In said document, it is proposed, more specifically, to enhance picture contours and, in particular, chrominance or luminance contours in a television picture, in order to improve the subjective quality of the successive pictures (it is clear, however, that said principle is also useful, in a more general manner, in other technical fields).

More precisely, the main stages of this specific processing arrangement are a circuit for calculating the derivative and the sign of the derivative of a sampled input signal, a normalization circuit, a circuit for carrying out a polynomial transformation centered around the normalized values, and, at the output of the normalization circuit, a denormalization circuit by means of which the initial dynamics of the signal can be recovered, an appropriate synchronization being performed between these various operations. However, it can be observed that this way of processing the input signal corresponds to a real-time, or on-line, use.

### SUMMARY OF THE INVENTION

It is therefore an object of the invention to propose a signal processing system not limited by this type of use.

To this end, the invention relates to a signal processing system comprising first electronic means for storing an input signal, second means for a real-time processing of the input signal thus stored, and third electronic means for storing the signal thus processed, said system being further characterized in that the second processing means themselves comprise off-line signal enhancement means applied to said input signal and using available processing resources, not still used for real-time or on-line processing, for delivering an enhanced signal and storing it in said third means for storing the signal processed by the second processing means.

In another advantageous embodiment of the invention, the invention relates to a signal processing system in which said signal enhancement means also comprise means for modifying said enhanced signal, said third electronic means for storing the processed signal being also able to store the enhanced signal thus modified.

In another embodiment of the invention, said third electronic means for storing the signal processed may be provided for outputting the enhanced signal and/or the modified enhanced signal in real time.

In a preferred embodiment of the invention, said signal enhancement means comprise one or a plurality of off-line signal processing functions the amount, quality and combination of which depend for example on the available processing power, or, in another example, on real-time constraints.

In a preferred application of the invention, said storing means are the video storage device of a home-video recording system, and the processor used for implementing the off-line signal enhancement function is a programmable part of the second means for a real-time processing of the stored input signal.

### BRIEF DESCRIPTION OF THE DRAWINGS

The present invention will now be described, by way of example, with reference to the accompanying drawings in which:

FIG. 1 shows a first, basic embodiment of a system according to the invention;

FIG. 2 shows a second, preferred embodiment of a system according to the invention.

### DETAILED DESCRIPTION OF THE INVENTION

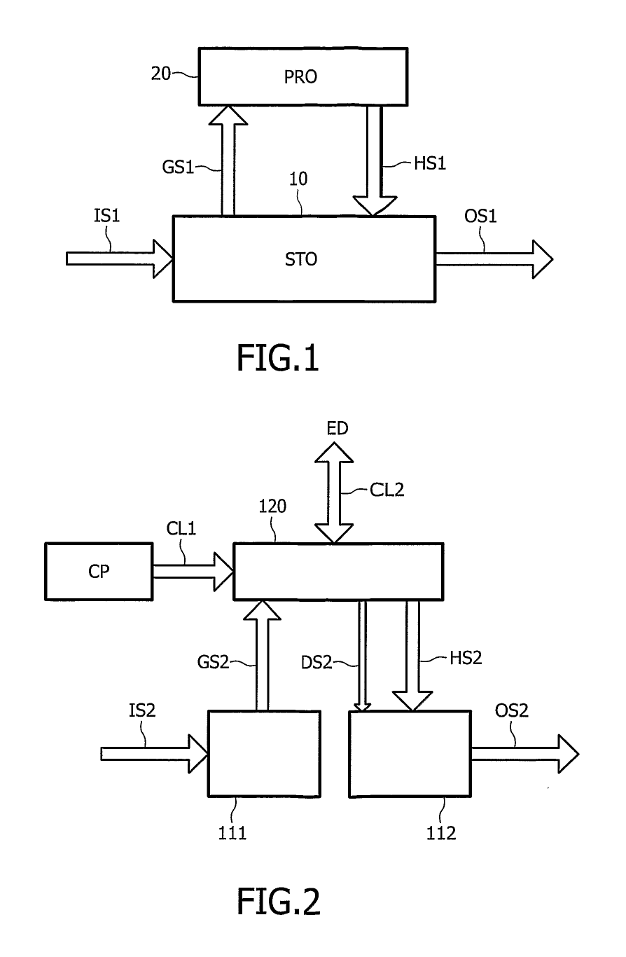

The proposed invention is illustrated in FIG. 1, for instance in the case of a video and/or an audio signal. The embodiment thus illustrated is in the form of a system including a storage unit 10 (STO), receiving an input signal IS1 and delivering an output signal OS1, and a processing unit 20 (PRO), receiving from said storage unit 10 an original signal GS1 and delivering, after having carried out the specific processing according to the invention, an enhanced signal HS1. The storage unit 10 stores the input data (in the present case, video and/or audio data), and the processing unit 20, according to the invention, autonomously enhances the stored signal and stores the signal thus enhanced, for later usage. This off-line enhancement is performed using available processing resources which are not being utilized for real time or on-line use, for instance the processing power available after the on-line processing, or available processing time. It has to be noted that the amount and the quality of said off-line processing depend on the amount of available resources (processing power or time), according to an improved concept of computational scalability which is an important aspect of the invention.

In another embodiment illustrated in FIG. 2, the storage device now includes two storage units 111 and 112, the first one receiving an input signal IS2 and the second one delivering an output signal OS2. A processing unit 120 receives from the storage unit 111 an original signal GS2 and processes it, the processing function performed in said processing unit 120 using control parameters CP received by means of a communication link CL1 and, if needed, data from an external database ED connected to said processing unit 120 by means of a communication link CL2. The processing unit 120 delivers, after said processing operation, an enhanced signal HS2, and may also add derived signals DS2. The control parameters CP define the amount, quality and combination of signal processing functions in the processing unit 120, depending on the available processing power at each moment and/or on the real-time requirements.

This invention can be used in any system that receives, stores, processes and/or transmits multimedia, i.e. in any multimedia equipment with embedded or integrated storage device, carrying out for instance functions such as noise reduction, picture stability improvement, advertisement removal, video format conversion, sharpness enhancement, layered coding, etc, said examples being not a limit to the scope of the invention but only an illustration of its broad scope.

The derived signals generated in the case of the embodiment of FIG. 2 may be used for auxiliary applications such as summary generation, content classification, enhancement layer generation (the difference between the enhanced signal HS2 and the original signal GS2 being then stored as an enhancement layer), and so on.

The processing unit is preferably a software programmable processor with or without function specific hardware. Some of the possible applications of the structure according to the invention may be a home server, for enhancing and recoding data for optimal transmission over a network, an Internet recorder, for downloading data from the Internet and enhancing result prior to usage, a video recorder, for storing broadcast and enhancing or summarizing before viewing, etc. All these applications may be easily up-gradable or extendable via software updates.

It can be noted that there are different ways of implementing functions by means of items of hardware or software, or both. In this respect, the drawings are very diagrammatic, each representing only one possible embodiment of the invention. Thus, although a drawing shows different functions as different blocks, this by no means excludes that a single item of hardware or software carries out several functions. Nor does it exclude that an assembly of items of hardware or software or both carry out a function. It is clear, also, that the detailed description, with reference to the drawings, illustrates rather than limits the invention. There are numerous alternatives, which fall within the scope of the appended claims. The word “comprising” does not exclude the presence of other elements or steps than those listed in a claim. The word “a” or “an” preceding an element or step does not exclude the presence of a plurality of such elements or steps.

1. A signal processing system comprising first electronic means for storing an input signal, second means for a real-time processing of the input signal thus stored, and third electronic means for storing the signal thus processed, said system being further characterized in that the second processing means themselves comprise off-line signal enhancement means applied to said input signal and using available processing resources, not still used for real-time or on-line processing, for delivering an enhanced signal and storing it in said third means for storing the signal processed by the second processing means.

2. A signal processing system according to claim 1, in which said signal enhancement means also comprise means for modifying said enhanced signal, said third electronic means for storing the processed signal being also able to store the enhanced signal thus modified.

3. A signal processing system according to claim 1, in which said third electronic means for storing the signal processed are provided for outputting the enhanced signal and/or the modified enhanced signal in real time.

4. A signal processing system according to claim 1, in which said signal enhancement means comprise one or a plurality of off-line signal processing functions the amount, quality and combination of which depend on the available processing power.

5. A signal processing system according to claim 1, in which said signal enhancement means comprise one or a plurality of off-line signal processing functions the amount, quality and combination of which depend on real-time constraints.

6. A signal processing system according to claim 1, in which said storing means are the video storage device of a home-video recording system, and the processor used for implementing the off-line signal enhancement function is a programmable part of the second means for a real-time processing of the stored input signal.
